(19) United States
(12) Patent Application Publication
(10) Pub. No.: US 2006/0278326 A1
(43) Pub. Date: Dec. 14, 2006

(54) Method for constructing a tyre casing

(76) Inventors: Werner Doering, Garbsen (DE); Jens Winkler, Hannover (DE); Udo Frerichs, Langenhagen (DE); Michael Hahn, Hannover (DE)

Correspondence Address: GREENBLUM & BERNSTEIN, P.L.C., 1950 ROLAND CLARKE PLACE, RESTON, VA, 20191, US

(21) Appl. No.: 10/570,494

(22) PCT Filed: Jun. 16, 2004
(86) PCT No.: PCT/EP04/06452

§ 371 Date: Mar. 3, 2006

(30) Foreign Application Priority Data
Sep. 5, 2003 (EP) 03020141.2

(51) Int. Cl. B29D 30/20; B60C 17/00

(52) U.S. Cl. 156/87; 156/123; 156/130.3; 152/517

(57) ABSTRACT

The invention relates to a method for building a tire casing on a tire building drum for a self-supporting radial tire, wherein the tire casing comprises an inner layer, reinforcing profiles for side walls as well as side walls, at least one casing ply and bead areas and wherein the tire building drum is provided with surrounding pockets for receiving the reinforcing profiles, characterized in that the regions of the reinforcing profiles (9) coming into contact with the inner layer (4) are provided with a groove structure, which comprises a plurality of grooves (12) extending in a continuous manner, in particular transverse to the circumferential direction of the tire building drum (10).

The invention relates to a method for building a tire casing on a tire building drum for a self-supporting radial tire, wherein the tire casing comprises an inner layer, reinforcing profiles for side walls as well as side walls, at least one casing ply and bead areas and wherein the tire building drum is provided with surrounding pockets for receiving the reinforcing profiles.

Self-supporting tires, which have been provided in the area of the side walls with reinforcing profiles that normally have a crescent-shaped cross section, have already been known for a long time. The purpose of these reinforcing profiles is keeping the tire self-supporting in the case of a sudden loss of pressure, i.e., in a breakdown, for a certain time or for a certain run capacity so that further travel is possible. This type of self-supporting tire is known from DE-A-29 43 654 for example. The tire is provided in the area of its side walls with a one-part or multi-part, approximately crescent-shaped, reinforcing profile, which is arranged between the inner layer and the casing ply and runs, on one end, just beneath the belt and, on the other end, up into the vicinity of the bead area.

In order to manufacture these types of radial tires for passenger vehicles, it is common to provide the tire building drum with recesses or surrounding pockets to guarantee a support of the casing ply(s) along a cylindrically rotating surface. To begin with, the inner layer is placed on the tire building drum and then the reinforcing profiles are positioned in the area of the two recesses or pockets. The contour of the recesses or the pockets is adapted to the outer contour of the still unvulcanized reinforcing profiles. In the process, slight inclusions of air arise between the inner layer and the positioned reinforcing profiles, which inclusions are undesirable since they affect the quality and service life of the tires.

As a result, it is the object of the invention to build tire casings for self-supporting tires with reinforcing profiles such that inclusions of air are avoided.

This object is attained according to one of the methods in accordance with the invention in that the regions of the reinforcing profiles coming into contact with the inner layer are provided with a groove structure, which comprises a plurality of grooves extending in a continuous manner, in particular transverse to the circumferential direction of the tire building drum.

As a result, this guarantees that air is drawn off in a particularly effective and simple manner so that inclusions of air can no longer form.

The groove structure on the affected regions of the reinforcing profiles can be created in a simple manner by grooved embossing cylinders, which impress the grooved structure on the reinforcing profiles by rolling off. The individual grooves of the grooved structure are preferably V-shaped in cross section and are created in this case with a depth of 0.3 to 1.2 mm, in particular 0.5 to 0.8 mm; the mutual distance between the grooves is approx. 1 to 2 mm.

The stated object is also attained by another method in accordance with the invention in which the inner layer is pre-formed corresponding to the contour of the recesses or pockets before it is applied to the tire building drum. This measure prevents deformation of the inner layer during application. It is precisely this that is otherwise responsible for creating inclusions of air.

Pre-forming the inner layer to adapt its contour to the contour of the tire building drum can also be carried out in a very simple manner. Suitable, for example, is the use of embossing rollers or embossing cylinders, which bring about the pre-forming of the inner layer by the application of mechanical pressure.

Heating of the inner layer, for example with hot air or electric heating of the embossing rollers or embossing cylinders, can be provided as a supporting measure.

The inner layer that is pre-formed or pre-embossed in this manner can be applied separately or with already positioned reinforcing profiles to the tire building drum.

In order to guarantee that the end areas of the inner layer that was applied together with the reinforcing profiles can overlap correspondingly in the circumferential direction after application, it is provided that the inner layer be positioned in an offset manner vis-à-vis the reinforcing profiles in the circumferential direction. The overlapping areas of the inner layer are therefore also offset in the circumferential direction vis-à-vis the abutting ends of the reinforcing profiles.

Inclusions of air between the reinforcing profiles in the inner layer can also be prevented in accordance with another embodiment of the invention in that the reinforcing profiles are applied to the tire building drums in such a way that they are gradually brought into contact with the inner layer during movement of the drum in the drum transverse direction. The reinforcing profiles are therefore inserted beginning little by little into the outer or inner corner area of the pockets.

In order to support a good arrangement of the pre-formed inner layer in the pockets of the drums, the raising process of the tire building drum can be conducted in two partial steps. To do so, the pre-formed inner layer is applied to the drum to begin with, the drum is raised up somewhat, then the reinforcing profiles and the casing ply(s) are positioned and finally the raising of the drum is completed.

Both in the case of grooved reinforcing profiles as well as with pre-formed inner layers, aeration bores, which extend into the recesses or pockets of the tire building drum and are connected to a network of channels or the like, can make sure that air is carried off.

Bores or channels in the area of the recesses or pockets can also be used for suctioning the inner layer onto the tire building drum. Compressed air can also be applied from the outside to the inner layer and thereby support a shaping of the inner layer to the recesses or pockets.

The invention will now be described in greater detail on the basis of the drawing, which diagrammatically depicts exemplary embodiments. They show:

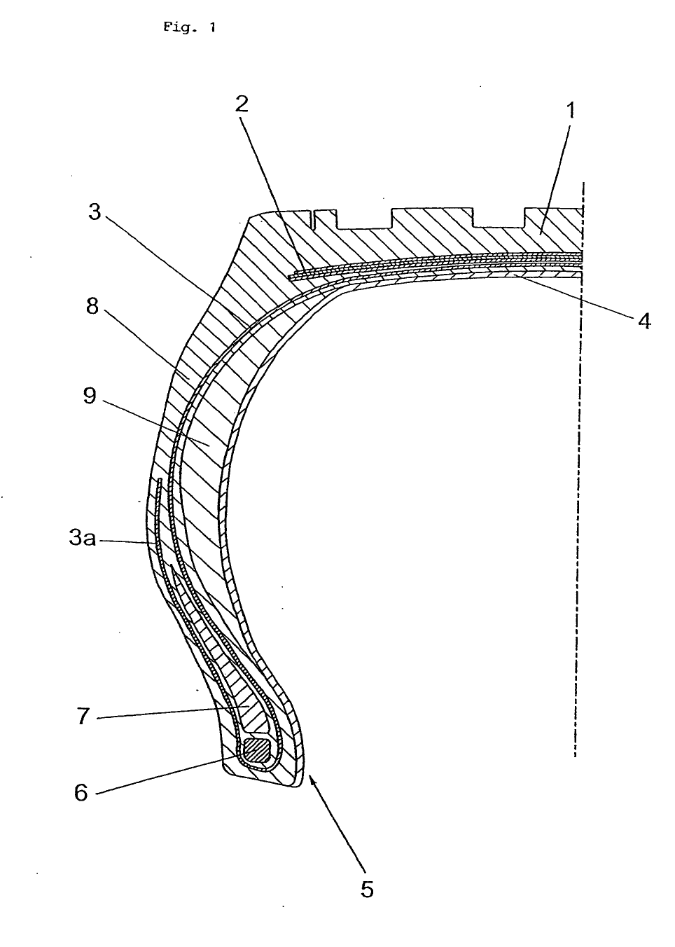

FIG. 1 A cross section through a self-supporting radial tire for passenger vehicles,

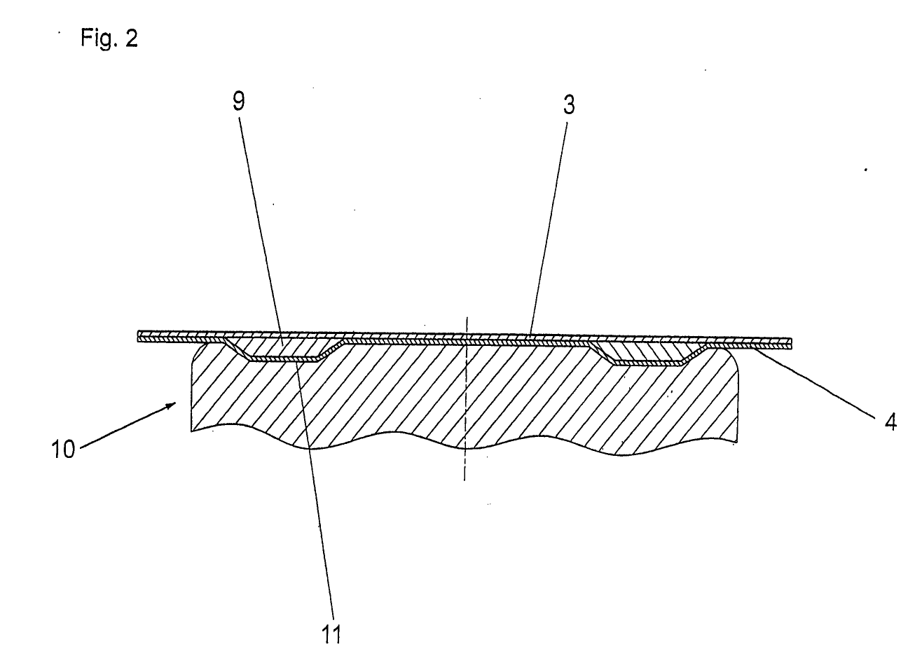

FIG. 2 A partial area of a building drum for manufacturing, a tire casing,

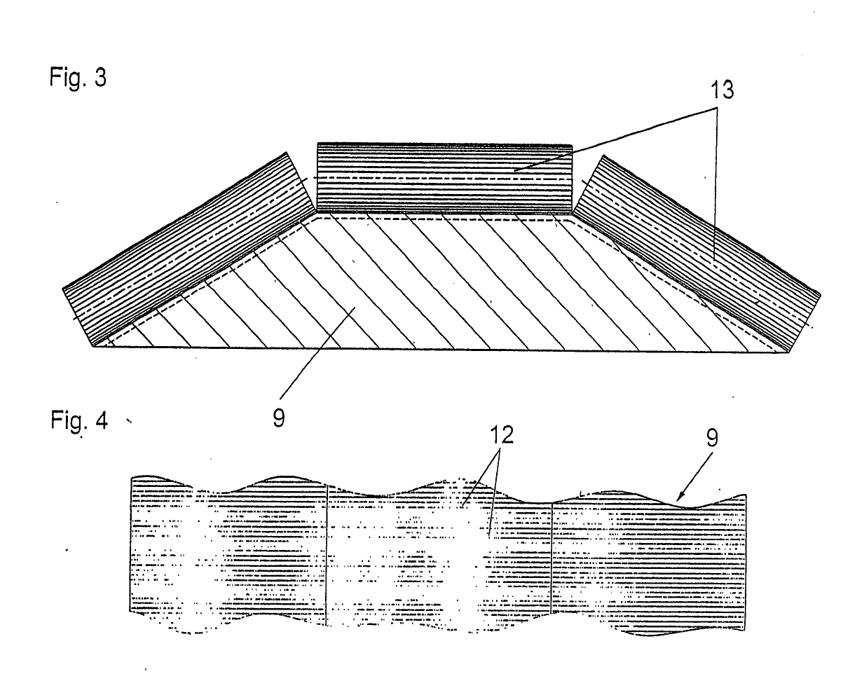

FIG. 3 A cross section through a reinforcing profile during processing by means of embossing cylinders, and

FIG. 4 A top view of a partial area of the reinforcing profile after processing by embossing cylinders.

FIG. 1 shows a cross section of a radial tire for passenger vehicles, which is a self-supporting tire. During a loss of pressure in a breakdown, the tire can therefore remain load-bearing at least over a certain run capacity such that further travel is possible. The essential components of which the tire is composed are a grooved tread rubber 1, a belt 2 that is two-ply in particular, a casing ply 3 preferably embodied as one layer, an inner layer 4 embodied to be airtight or largely airtight, beads 5 with bead cores 6 and core profiles 7, side walls 8 and reinforcing profiles 9 that are approximately crescent-shaped in cross section. The two plies of the belt 2 can be composed in a known manner of tire cords made of steel cord embedded in a rubber mixture, which run parallel to one another within every ply, wherein the steel cords of the one ply are oriented in a crossed arrangement to the steel cords of the second ply and each enclose an angle between 15 and 30° with the tire circumferential direction. The reinforcing profiles 9 are arranged between the inner layer 4 and the casing ply 3 and extend up to beneath the edge areas of the belt 2 as well as into the vicinity of the bead cores 6 or even up to next to these. The arrangement of the reinforcing profiles 9 and the execution thereof are not the subject of this invention.

The casing ply 3 is guided around the bead core 6 in each bead 5 coming from the axial inside and extends in the direction of the belt 2 up to a certain height in the respective side wall 8 and in this way forms the so-called turn-up 3a. The core profile 7 is arranged above each bead core 6 between the turn-up 3a and the casing ply 3.

The structure of a tire of this type is yielded from the unvulcanized components. In a two-step building method, the so-called tire casing is first prepared on a cylindrical tire building drum, the main components of which tire casing are the inner layer 4, the reinforcing profiles 9, the casing ply 3, the bead cores 6 and the core profiles 7.

FIG. 2 shows a view of a cylindrical tire building drum 10. The tire building drum 10 is provided on its circumference with two surrounding recesses or pockets 11 for inserting the reinforcing profiles 9 so that the casing ply 3 can be placed on the tire building drum along a cylinder jacket surface after positioning the inner layer 4 and the reinforcing profiles 9. The inner contour of the surrounding pockets 11 is adapted to the cross-sectional contour of the reinforcing profiles 9.

FIG. 3 shows an embodiment of a reinforcing profile 9, which was extruded in the depicted case in the cross section of an equilateral trapezoid. The wide base surface of the reinforcing profiles 9 along with the outer surface of the building drum 10 forms the cylindrical bearing surface for the casing ply 3 with positioned reinforcing profiles 9.

As FIG. 3 shows, in order to prevent inclusions of air between the inner layer 4 and the reinforcing profiles 9 during tire building, the surfaces of the reinforcing profile 9 that come into contact with the inner layer 4 are provided with a groove structure transverse to the circumferential direction so that these surfaces are provided with grooves 12 that run straight and parallel to one another in sections from side edge to side edge. Embossing cylinders 13 provided with a corresponding grooved structure are used to create these grooves 12. The grooves 12 are preferably V-shaped, have a depth of approx. 0.5 mm, in particular between 0.3 and 1.2 mm, the mutual distance between the grooves 12 is approx. 1 to 2 mm. The grooves prevent inclusions of air from arising between the inner layer 4 and the reinforcing profiles 9 since any excess air is laterally carried off in any case.

Alternatively or additionally, further measures can be undertaken to prevent inclusions of air from arising or to carry off air.

Thus, in accordance with another embodiment of the invention, the contour of the inner layer 4 can be pre-formed before applying the tire building drum 10 in such a way that it corresponds to the contour of the pockets 11 in the tire building drum 10. This can take place using a pre-forming device in the servicer or shortly before the inner layer 4 is wound on the tire building drum 10. Correspondingly contoured embossing rollers or embossing cylinders can be used for pre-forming. The pre-forming process of the inner layer 4 can be supported by heating the inner layer 4 with hot air or heating the embossing rollers or embossing cylinders. A corresponding heating of the areas of the tire building drum 10 featuring the pockets 11 can also support optimum positioning of the inner layer 4. A further measure, which facilitates optimum positioning of both a pre-formed and non-pre-formed inner layer 4 on the tire building drum 10, is the provision of channels on the tire building drum 10 in the area of the pockets 11; via which channels the inner layer 4 can be suctioned or the air can be carried off.

Pressing the inner layer 4 into the pockets 11 from the outside can be supported via additional measures, for example, by means of compressed air.

In another embodiment, the pre-formed inner layer 4 together with the already introduced reinforcing profiles 9 can be applied to the tire building drum 10. The bringing together of the inner layer 4 and reinforcing profiles 9 can take place in the servicer or between servicer and tire building drum. In doing so, it must be guaranteed that the end areas of the inner layer 4 can overlap after application to the tire building drum, but that the ends of the reinforcing profiles 9 abut one another in a blunt manner. A mutual offset of the reinforcing profiles 9 vis-à-vis the inner layer 4, which is executed longer than the reinforcing profiles 9, permits a creation of the overlapping area of the inner layer 4 before the ends of the reinforcing profiles 9 abut one another in a blunt manner.

In another embodiment, the reinforcing profiles 9 can be placed on the pre-formed inner layer 4 already applied to the tire building drum such that a gradual contact of the profiles 9 with the inner layer 4 takes place. To do this, the profiles 9 are “tilted” bit by bit onto the inner layer 4 when rotating the drum either from the outer or inner end area. This prevents inclusions of air from arising.

In accordance with another embodiment of the invention, the pre-formed inner layer 4 is first applied to the drum, the drum is raised up somewhat so that the inner layer 4 comes to bear in the pockets 11, then the reinforcing profiles 9 and the casing ply(s) are positioned and finally the raising of the drum is completed.

1. Method for building a tire casing on a tire building drum for a self-supporting radial tire, wherein the tire casing comprises an inner layer, reinforcing profiles for side walls as well as side walls, at least one casing ply and bead areas and wherein the tire building drum is provided with surrounding pockets for receiving the reinforcing profiles, characterized in that the regions of the reinforcing profiles (9) coming into contact with the inner layer (4) are provided with a groove structure, which comprises a plurality of grooves (12) extending in a continuous manner, in particular transverse to the circumferential direction of the tire building drum (10).

2. Method according to claim 1, characterized in that the groove structure is created by means of embossing cylinders.

3. Method according to claim 1, characterized in that the grooves (12) of the groove structure have at least essentially a V-shaped cross section.

4. Method according to claim 1, characterized in that the grooves (12) of the groove structure have a depth of 0.3 to 1.2 mm, in particular 0.5 to 0.8 mm.

5. Method according to claim 1, characterized in that the mutual distance between the grooves (12) is 1 to 2 mm.

6. Method for building a tire casing on a tire building drum for a self-supporting radial tire, wherein the tire casing comprises an inner layer, reinforcing profiles for side walls as well as side walls, at least one casing ply and bead areas and wherein the tire building drum is provided with surrounding pockets for receiving the reinforcing profiles, characterized in that the inner layer (4) is pre-formed corresponding to the contour of the recesses or pockets (11) before it is applied to the tire building drum (10).

7. Method according to claim 6, characterized in that the pre-forming of the inner layer (4) is carried out with embossing rollers or embossing cylinders.

8. Method according to claim 6, characterized in that the pre-forming is carried out by heating the inner layer (4), for example by means of hot air, or heating the embossing rollers or embossing cylinders.

9. Method according to claim 6, characterized in that the inner layer (4) is applied with already positioned reinforcing profiles (9) to the tire building drum (10).

10. Method according to claim 8, characterized in that the inner layer (4) is positioned in an offset manner vis-à-vis the reinforcing profiles (8) in the circumferential direction of the drum.

11. Method according to claim 6, characterized in that the reinforcing profiles (9) are gradually brought into contact with the inner layer (4) while rotating the drum in the drum transverse direction.

12. Method according to claim 6, characterized in that the pre-formed inner layer (4) is applied to the drum, the drum is raised up somewhat so that subsequently the reinforcing profiles (9) and the casing ply(s) are positioned and finally the raising of the drum is completed.

13. Method according to claim 1, characterized in that the tire building drum (10) is provided with bores or channels in the area of the pockets (11).

14. Method according to claim 1, characterized in that the positioned inner layer (4) is acted upon from outside with compressed air.

15. Vehicle pneumatic tire in a radial design, which is manufactured in accordance with the method according to claim 1.
